(19) United States
(12) Patent Application Publication
(10) Pub. No.: US 2023/0106295 A1
(43) Pub. Date: Apr. 6, 2023

(54) SYSTEM AND METHOD FOR DERIVING A PERFORMANCE METRIC OF AN ARTIFICIAL INTELLIGENCE (AI) MODEL

(71) Applicant: Intelus Inc., Clyde Hill, WA (US)

(72) Inventor: Patrice Simard, Clyde Hill, WA (US)

(73) Assignee: Intelus Inc., Clyde Hill, WA (US)

(21) Appl. No.: 18/071,355

(22) Filed: Nov. 29, 2022

Related U.S. Application Data
(63) Continuation-in-part of application No. 17/582,996, filed on Jan. 24, 2022.
Application No. 17/582,996 is a continuation-in-part of application No. 17/410,608, filed on Aug. 24, 2021.
Application No. 17/410,608 is a continuation-in-part of application No. 17/337,726, filed on Jun. 3, 2021.

(51) Int. Cl. G06N 5/022

(52) U.S. Cl. CPC G06N 5/022

(57) ABSTRACT

A processor-implemented method for deriving at least one performance metric of an artificial intelligence (AI) model that is trained based on a sample set of examples (E), by estimating a relative size of a first partition of the sample set of examples (E) is provided. The method includes populating a binary decision tree by adding at least one unlabeled example from the sample set of examples (E) at a root node of the binary decision tree, partitioning the sample set of examples (E) into the first partition that includes a subset of the sample set of examples (E), propagating the at least one unlabeled example from the root node to the first leaf node in the binary decision tree and automatically estimating the relative size of the first partition that corresponds to the first leaf node to derive the at least one performance metric of the AI model.

### BACKGROUND

### Technical Field

Embodiments of this disclosure generally relate to artificial intelligence and machine learning, and more particularly, to a method and a system for deriving a performance metric of an artificial intelligence (AI) model.

### Description of the Related Art

Artificial Intelligence (AI) is a subfield within computer science associated with constructing machines that can augment or emulate human intelligence. AI research deals with the question of how to create computers that are capable of intelligent behavior. In recent years, due to advances in the performance of computer hardware, sizes of training sets, and theoretical understanding of artificial intelligence, AI has enabled advances in other technical fields also, such as recognition and prediction systems. For example, Artificial Intelligence (AI) models have been used to provide personalized recommendations to people, based for example on their previous searches and purchases or other online behavior.

AI uses data to create and train AI algorithms, which can process vast amounts of data and turn it into valuable insights. To make data actionable, it is often labeled so that a computer can comprehend it. Data labeling is the process of adding tags to data points to train a machine learning algorithm. Each time an example in a dataset is labeled, the AI model is updated, and with more data and labels, the performance of the AI model improves. The performance of an AI model is characterized by performance metrics such as marginale, precision, recall, and F1 score measured on a labeled test set. A standard problem in AI is to obtain an unbiased labeled test set. Examples obtained through random sampling are unlikely to represent all the classes if the classes are not balanced. Using labeled examples from the training set in the test set can introduce bias and inaccurate metric measurements. A standard way to avoid bias is to partition the distribution into partitions and compute the metrics using stratified sampling, such that the statistics inside each stratum is unbiased. Some characteristics of the stratum, such as its size, or the AI model score can be estimated with unlabeled examples, which saves on human labeling but requires compute time. These performance metrics change dynamically as more labels are added and multiple iterations are performed. Each time the AI model is retrained and updated after adding a label or changing a feature, measurement of these performance metrics helps to determine how the update impacts the performance of the AI model.

Unfortunately, computing such performance metrics each time the model is updated takes up a lot of computational resources, particularly when these performance metrics have to be calculated accurately. Each time a performance metric is computed, it takes a significant amount of time and slows down the performance of the system after each label is added or the feature is changed in the AI model. These escalating delays lead to a poor experience for a person who is labeling and training the AI model.

Accordingly, there remains a need to improve measurement of performance metrics of an AI model dynamically as the AI model gets trained and updated.

### SUMMARY

In view of the foregoing, embodiments herein provide a processor-implemented method for deriving at least one performance metric of an artificial intelligence (AI) model that is trained based on a sample set of examples (E), by estimating a relative size of a first partition of the sample set of examples (E). The method includes (i) populating a binary decision tree by adding at least one unlabeled example from the sample set of examples (E) at a root node of the binary decision tree, (ii) partitioning the sample set of examples (E) into the first partition that includes a subset of the sample set of examples (E), (iii) propagating the at least one unlabeled example from the root node to the first leaf node in the binary decision tree and (iv) automatically estimating the relative size of the first partition that corresponds to the first leaf node to derive the at least one performance metric of the AI model. The first partition includes the subset of the sample set of examples (E) that have propagated to the first leaf node of the binary decision tree.

In some embodiments, the at least one unlabeled example that is added to populate the binary decision tree is selected from the at least one unlabeled example that are added at the root node of the binary decision tree, and the at least one unlabeled example is propagated from the root node to the first leaf node in the binary decision tree by applying a predicate at each parent node along a path from the root node to the first leaf node.

In some embodiments, the at least one unlabeled example is propagated from the root node to the first leaf node by applying a root predicate to the unlabeled example at the root node to obtain a logical value, and assigning the at least one unlabeled example to a left child node of the root node or a right child node of the root node based on the logical value, and iteratively applying predicates to the at least one unlabeled example at each child node that the at least one unlabeled example is assigned to, until the at least one unlabeled example reaches the first leaf node.

In some embodiments, the method further includes selecting a first predicate and pseudo-randomly selecting at least one example from the sample set of examples (E) which satisfies the predicate and labeling the at least one selected example for which a first logical value obtained by applying the first predicate to the at least one example is true to obtain at least one labeled example; and propagating the at least one labeled example to a second partition that corresponds to a second leaf node of the binary decision tree to obtain an unbiased label estimate for an intersection of the second partition and the set of examples satisfying the predicate. In some embodiments, the at least one performance metric is derived based at least in part on the unbiased label estimate for the second partition. In some embodiments, the at least one performance metric is selected from marginale or precision.

In some embodiments, the method further includes modifying the binary decision tree by splitting the second leaf node into a first child leaf node and a second child leaf node based on a second logical value derived from a second predicate that is applied to the at least one labeled example that has propagated to the second leaf node.

In some embodiments, the relative size of the first leaf node is estimated by dividing a count of unlabeled examples that have propagated to the first leaf node by a total number of unlabeled examples added at the root node.

In some embodiments, if the at least one unlabeled example is propagated from the root node to the first leaf node in the binary decision tree, for each child node that the at least one unlabeled example is assigned to along the path between the root node and the first leaf node, a ratio of unlabeled examples assigned to the each child node to the number of unlabeled examples at its parent node is determined, and a product of the ratio at the each child node is estimated to be the relative size of the first leaf node.

In some embodiments, the method further includes performing an incremental update by propagating a subset of the at least one unlabeled example to the second leaf node; and estimating a relative size of the first child leaf node after the incremental update is completed.

In some embodiments, the method further includes estimating a count of unlabeled examples to be added to populate the binary decision tree based on a demand for a number of unlabeled examples needed to propagate down to the first leaf node to achieve a preset target minimum of unlabeled examples at the first leaf node, based on a historical proportion split at each node along the path from the root node to the first leaf node.

In some embodiments, the at least one performance metric is selected from any of marginale, precision, recall, and F1 score.

In one aspect, a system for deriving at least one performance metric of an artificial intelligence (AI) model that is trained based on a sample set of examples (E), by estimating a relative size of a first partition of the sample set of examples (E) is provided. The system includes a processor and a non-transitory computer readable storage medium storing one or more sequences of instructions, which when executed by the processor, performs a method that includes: (i) populating a binary decision tree by adding at least one unlabeled example from the sample set of examples (E) at a root node of the binary decision tree, (ii) partitioning the sample set of examples (E) into the first partition that includes a subset of the sample set of examples (E), (iii) propagating the at least one unlabeled example from the root node to the first leaf node in the binary decision tree and (iv) automatically estimating the relative size of the first partition that corresponds to the first leaf node to derive the at least one performance metric of the AI model. The first partition includes the subset of the sample set of examples (E) that have propagated to the first leaf node of the binary decision tree.

In some other embodiments, the at least one unlabeled example that is added to populate the binary decision tree is selected from the at least one unlabeled example that is added at the root node of the binary decision tree, and the at least one unlabeled example is propagated from the root node to the first leaf node in the binary decision tree by applying a predicate at each parent node along a path from the root node to the first leaf node.

In some still other embodiments, the at least one unlabeled example is propagated from the root node to the first leaf node by applying a root predicate to the unlabeled example at the root node to obtain a logical value, and assigning the at least one unlabeled example to a left child node of the root node or a right child node of the root node based on the logical value, and iteratively applying predicates to the at least one unlabeled example at each child node that the at least one unlabeled example is assigned to, until the at least one unlabeled example reaches the first leaf node.

In some other embodiments, the method further includes selecting a first predicate and pseudo-randomly selecting at least one example from the sample set of examples (E) which satisfies the predicate and labeling the at least one selected example for which a first logical value obtained by applying the first predicate to the at least one example is true to obtain at least one labeled example; and propagating the at least one labeled example to a second partition that corresponds to a second leaf node of the binary decision tree to obtain an unbiased label estimate for an intersection of the second partition and the set of examples satisfying the predicate. In some other embodiments, the at least one performance metric is derived based at least in part on the unbiased label estimate for the second partition. In some other embodiments, at least one performance metric is selected from marginale or precision.

In some other embodiments, the method further includes modifying the binary decision tree by splitting the second leaf node into a first child leaf node and a second child leaf node based on a second logical value derived from a second predicate that is applied to the at least one labeled example that has propagated to the second leaf node.

In some other embodiments, the relative size of the first leaf node is estimated by dividing a count of unlabeled examples that have propagated to the first leaf node by a total number of unlabeled examples added at the root node. For example, if a leaf has 200 unlabeled examples and another leaf has 20 unlabeled examples, then the size of this leaf may be ten times bigger than the size that has one 10th of the unlabeled examples.

In some other embodiments, if the at least one unlabeled example is propagated from the root node to the first leaf node in the binary decision tree, for each child node that the at least one unlabeled example is assigned to along the path between the root node and the first leaf node, a ratio of unlabeled examples assigned to the each child node to the number of unlabeled examples at its parent node is determined, and a product of the ratio at the each child node is estimated to be the relative size of the first leaf node.

In some other embodiments, the method further includes performing an incremental update by propagating a subset of the at least one unlabeled example to the second leaf node; and estimating a relative size of the first child leaf node after the incremental update is completed.

In some other embodiments, the method further includes estimating a count of unlabeled examples to be added to populate the binary decision tree based on a demand for a number of unlabeled examples needed to propagate down to the first leaf node to achieve a preset target minimum of unlabeled examples at the first leaf node, based on a historical proportion split at each node along the path from the root node to the first leaf node.

In some other embodiments, the at least one performance metric is selected from any of marginale, precision, recall, and F1 score.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a server having an artificial intelligence (AI) model that is updated using a user device and evaluated using a model performance evaluation module, according to some embodiments herein;

FIG. 2 is an exemplary diagram that illustrates a binary decision tree according to some embodiments herein;

FIG. 3 is an exemplary diagram that illustrates populating a binary decision tree by adding an unlabeled example from a sample set of examples (E) at a root node of the binary decision tree according to some embodiments herein;

FIG. 4A is an exemplary diagram that illustrates modifying a binary decision tree by splitting a second leaf node into a first child leaf node and a second child leaf node according to some embodiments herein;

FIG. 4B is an exemplary diagram that illustrates performing an incremental update by propagating a subset of unlabeled examples to the second leaf node of FIG. 4A according to some embodiments herein;

FIG. 5 is a block diagram of a model performance evaluation module of FIG. 1 according to some embodiments herein;

FIG. 6 is an exemplary diagram that illustrates populating the binary decision tree by adding the unlabeled example from a sample set of examples (E) at the root node of the binary decision tree according to some embodiments herein;

FIG. 7 is a flow diagram that illustrates a method for deriving performance metrics of the artificial intelligence (AI) model that is trained based on a sample set of examples (E), by estimating a relative size of a first partition of the sample set of examples (E) according to some embodiments herein;

FIG. 8 is a flow diagram that illustrates a method for propagating a labeled example to a second partition that corresponds to a second leaf node of a binary decision tree according to some embodiments herein; and

FIG. 9 is a schematic diagram of a computer having a computer architecture in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As used herein, the following terms and phrases shall have the meanings set forth below. Unless defined otherwise, all technical terms used herein have the same meaning as commonly understood to one of ordinary skill in the art. The singular forms “a,” “an,” and “the” include plural reference unless the context clearly dictates otherwise.

As used herein, the word “tree” refers to a mathematical model for data types that represents a hierarchical tree structure with a set of connected tree elements called “nodes”. The lines connecting the nodes are called “branches”. Nodes without child nodes are called leaf nodes or “leaves”. Every finite tree structure has a member that has no superior, or parent. This member is called the “root” or root node. The root is the starting node. Each node in the tree can be connected to many child nodes, but must be connected to exactly one parent node, except for the root node. Each child node can be treated like the root node of its own subtree.

A “binary decision tree” refers to a tree structure in which a decision is made at each node, and the output of the decision is a binary logical value. In some embodiments, the binary logical value is either TRUE or FALSE.

A “path” in a binary tree is a sequence of nodes where each pair of adjacent nodes in the sequence has an edge connecting them.

A “predicate” is a function that returns a binary logical value, which in some embodiments is either TRUE or FALSE, based on a condition.

The term “partition model” refers to an AI model that is trained based on a sample set of examples (E), where the sample of examples (E) is partitioned into partitions. The partition model may be represented by a mathematical model for data types, which is the binary decision tree. The partition model may be built incrementally as the binary decision tree, and defined by a root node, child nodes and leaf nodes of the binary decision tree.

The term, “propagation” refers to the process in which an element traverses along a path from the root node of the binary decision tree to its child nodes, from which it may traverse further iteratively all the way to a leaf node. At each node, a predicate may be applied to the element. Based on a logical value obtained by applying the predicate to the element, it traverses to a left child node or a right child node.

An “unlabeled example” is an example that is yet to be labeled, which may be populated (e.g. introduced or injected) at the root node. Unlabeled examples (which may also be called “proxies”) may be used to estimate a relative size of a partition in a computationally efficient manner.

A “relative size” of a partition may be estimated as a ratio of the number of unlabeled examples that have propagated to a leaf node that corresponds to the partition, to the total number of unlabeled examples that were populated at the root node. Advantageously, the natural distribution of the unlabeled examples can be partitioned such that the statistics can be computed independently on each partition. Each partition is sampled and the relative size is estimated to compute global statistics. This partitioning and sampling settings will be familiar to those of ordinary skill in the field who have used and understood stratified sampling. Maintaining these updated partitions and keeping accurate estimates of their sizes is a key aspect.

The term “precision” is the ratio of system-generated results that correctly predicted positive observations (True Positives) to the system's total predicted positive observations, both correct (True Positives) and incorrect (False Positives). In other words, precision finds out what fraction of predicted positives is actually positive.

The term “recall” is the ratio of system-generated results that correctly predicted positive observations (True Positives) to all observations that are actually positive (Actual Positives). In other words, recall measures the model's ability to predict the positives.

The term “F1 Score” is the weighted average (or harmonic mean) of precision and recall. The F1 score takes both False Positives and False Negatives into account to strike a balance between the Precision and the Recall.

The term “accuracy” is a ratio of the correctly predicted classifications (both True Positives+True Negatives) to the total Test Dataset.

The term “marginate” is the probability that an element of a sample set of examples (E) that is sampled randomly has a positive value.

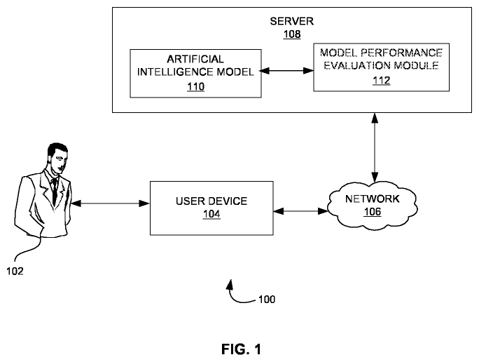

Referring now to the drawings, and more particularly to FIGS. 1 through 9, preferred embodiments are shown, where similar reference characters denote corresponding features consistently throughout the figures.

FIG. 1 is a block diagram 100 that illustrates a server 108 having an artificial intelligence (AI) model 110 that is updated using a user device 104 and evaluated using a model performance evaluation module 112, according to some embodiments herein. The block diagram 100 includes the user device 104 associated with a user 102, a network 106, the server 108 includes the AI model 110, and the model performance evaluation module 112. In some embodiments, the user device 104 associated with the user 102 communicates with the server 108 through the network 106. In some embodiments, the network 106 is a wired network. In some embodiments, the network 106 is a wireless network. In some embodiments, the network 106 is a combination of the wired network and the wireless network. In some embodiments, the network 106 is the Internet. A list of devices that are capable of functioning as the server 108, without limitation, may include a server network, a mobile phone, a Personal Digital Assistant (PDA), a tablet, a desktop computer, or a laptop.

The model performance evaluation module 112 of the server 108 partitions the sample set of examples (E) into a first partition that includes a subset of the sample set of examples (E). The first partition includes the subset of the sample set of examples (E) that have propagated to a first leaf node of the binary decision tree. At least one unlabeled example is added to populate the binary decision tree at the root node of the binary decision tree. The at least one unlabeled example may be selected from unlabeled examples (e.g. a batch of examples) that are added at the root node. Adding the unlabeled examples does not modify the structure of the binary decision tree. In some embodiments, adding the unlabeled example from the sample set of examples (E) at the root node is progressive and initiated after each update of the binary decision tree, or in some embodiments, less often. For example, only a few 10s or 100s unlabeled examples may be populated at the root node and propagated to leaves.

The model performance evaluation module 112 automatically estimates the relative size of the first partition that corresponds to the first leaf node to derive the performance metrics of the AI model 110. A subset of the sample set of examples (E) to the leaves can be propagated to the leaves asynchronously and/or incrementally, such that at any given time, for each partition, a logical value of at least one element in the partition is estimated, and a relative size of the partition can be determined. The logical value of at least one element in the partition, and the relative size of the partition can be used to compute the performance metrics of the AI model 110. In some embodiments, the performance metrics of the AI model 110 may be selected from any of marginale, precision, recall, and F1 score. The model performance evaluation module 112 may compute the performance metrics every time the AI model 110 is retrained after adding a label or changing a feature.

For example, the model performance evaluation module 112 may select a first predicate and pseudo-randomly select an example from the sample set of examples (E) which satisfies the predicate and label the selected example for which a first logical value obtained by applying the first predicate to the example is true to obtain a labeled example. The model performance evaluation module 112 may propagate the labeled example to a second partition that corresponds to a second leaf node of the binary decision tree to obtain an unbiased label estimate for an intersection of the second partition and the set of examples satisfying the predicate. Since the example is pseudo-randomly selected, the label estimate for the second partition is considered to be unbiased. The model performance evaluation module 112 derives the performance metrics based at least in part on the unbiased label estimate for the second partition. For example, global statistics can be computed from each of the partitions' unbiased estimates by weighting their influence by the partition's sizes. For instance, the probability of a class over the set of examples (E) is the weighted sum of the probabilities of that class on each partition.

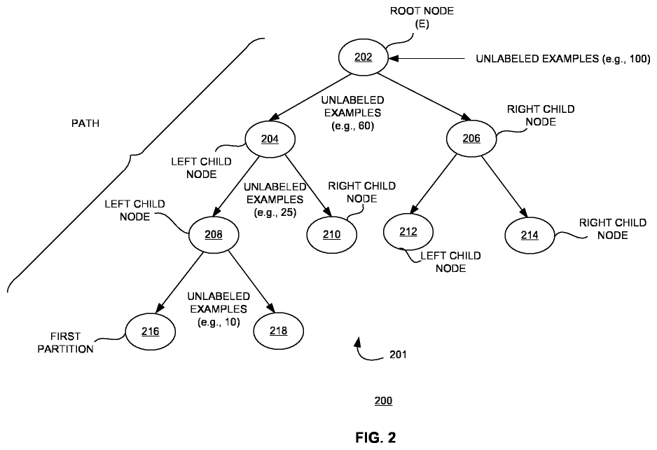

FIG. 2 is an exemplary diagram 200 that illustrates a binary decision tree 201 according to some embodiments herein. The binary decision tree 201 begins with a root node 202. The root node 202 branches out into a left child node 204 and a right child node 206. In some embodiments, each child continues to branch out into left child nodes 208, 212, and 216 and right child nodes 210, 214, and 218. For example, the left child node 204 has child nodes such as the left child node 208 and the right child node 210, and the right child node 206 has the child nodes such as the left child node 212 and the right child node 214. Similarly, the left child node 208 has the child nodes such as the left child node 216 and the right child node 218. The left child node 216 may be a first leaf node. In some embodiments, partitions are represented as leaf nodes in the binary decision tree 201. The partition includes unlabeled examples that have propagated to the first leaf node, e.g., the left child node 216. The partition is a subset of the sample set of examples that have propagated to (or that correspond to) the first leaf node, e.g., the left child node 216.

In FIG. 2, a batch of unlabeled examples is populated at the root node 202, and the unlabeled examples are split at each child node along the path. For example, 100 unlabeled examples are populated at the root node 202, then the unlabeled examples are split through propagation into 60 unlabeled examples at the left child node 204. Some of the unlabeled examples may be propagated to the right child node 206, e.g., 40 unlabeled examples at the right child node 206. Further, the unlabeled examples may be split into 25 unlabeled examples at the left child node 208. Some of the unlabeled examples may be propagated to the right child node 210, e.g., 35 unlabeled examples at the right child node 210. Then the unlabeled examples may be split into 10 at the left child node 216, i.e., the first leaf node and 15 at the right child node 218. In that case, the relative size of the partition that corresponds to the first leaf node will be 10/100=0.1. Further, 40 unlabeled examples in the right child node 206 are split into 3 unlabeled examples in a left child node 212 and 37 unlabeled examples in a right child node 214. In that case, an estimate for every leaf of the partition, namely: 0.1 (216), 0.15 (218), 0.35 (210), 0.03 (212), and 0.37 (214). The sum of probability estimates is 1, as expected, since the leaves form a partition. If the set of examples used to populate the root node at 202 is picked at random, the number of examples that end up at each leaf divided by the batch size is an unbiased estimate of the size of the partition defined by the corresponding leaf.

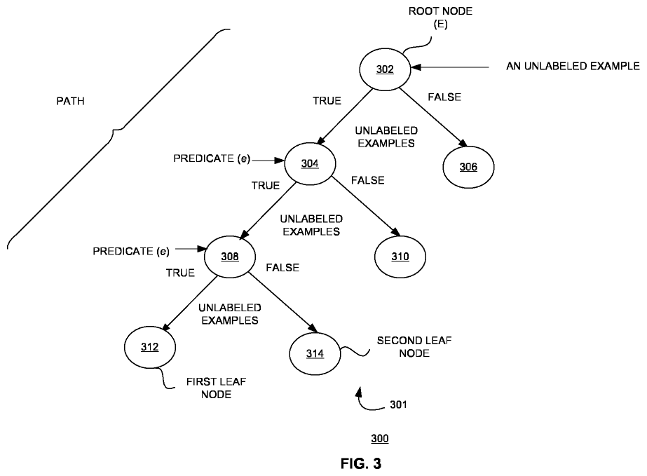

FIG. 3 is an exemplary diagram 300 that illustrates populating a binary decision tree 301 by adding an unlabeled example from a sample set of examples (E) at a root node 302 of the binary decision tree 301 according to some embodiments herein. The exemplary diagram 300 includes the binary decision tree 301 that includes the root node 302, left child nodes 304, 308, and 312, and right child nodes 306, 310, and 314. In some embodiments, each child continues to branch out into left child nodes 304, 308, 312 and right child nodes 306, 310 and 314. For example, the left child node 304 has child nodes such as a left child node 308 and a right child node 310, and the left child node 308 has the child nodes such as a left child node 312 and a right child node 314. In some embodiments, the left child node 312 is a first leaf node and the right child node 314 is a second leaf node.

The sample set of examples (E) is partitioned into a first partition that includes a subset of the sample set of examples (E). Each of the leaves includes a different and disjoint subset of the propagated examples, i.e., there is no overlap between the subset of the sample set of examples (E). The unlabeled example is propagated from the root node 302 to the first leaf node 312 in the binary decision tree 301. The first partition includes the subset of the sample set of examples (E) that have propagated to the first leaf node, e.g., the left child node 312 of the binary decision tree 301.

In some embodiments, the AI model 110 is trained for each unlabeled example e of a set E to produce a score.

e∈E→model(e)∈R model:

In some embodiments, if the score is equal or above a threshold k The unlabeled example is classified by the model performance evaluation module 112 as positive. In some embodiments, if the score is below the threshold k The unlabeled example is classified by the model performance evaluation module 112 as negative.

e∈E→label( )∈{true,false} label:

The unlabeled example may be propagated from the root node 302 to the first leaf node 312 in the binary decision tree 301 by applying a predicate (e) at each parent node, e.g., nodes 304, 308 along a path from the root node 302 to the first leaf node 312. In some embodiments, the predicate is dependent on the content of a document. In some embodiments, predicates may be, for example, a query raised by the user 102, e.g., does document e contains a word ‘recipe”, or a model-based query, which can be automatically generated, e.g., is the score of the current model evaluated on e greater or less than a threshold k?. The unlabeled examples for which the predicate is true may propagate to the left child nodes, e.g., 304, 308, and 312, and the unlabeled examples for which the predicate is false may propagate to the right child nodes, e.g., 306, 310 and 314.

The unlabeled example may be propagated from the root node 302 to the first leaf node 312 by (i) applying a root predicate to the unlabeled example at the root node 302 to obtain a logical value, (ii) assigning the unlabeled example to the left child node 304 of the root node 302 or the right child node 306 of the root node 302 based on the logical value, and (iii) iteratively applying predicates to the unlabeled example at each child node that the unlabeled example is assigned to until the unlabeled example reaches the first leaf node 312. The partition is defined by the leaves of the tree. The model performance evaluation module 112 may descend the binary decision tree 301 from the root node 302 to determine the unlabeled example belongs to the partition, by evaluating the predicate at each node and following the left child node 304 if the predicate is true and the right child node if the predicate is false, until the unlabeled example reaches the first leaf node 312.

In some embodiments, each unlabeled example ends up in one leaf, thus

?ᵢUᵢ=E

Uᵢ?Uⱼ=? for i≠j

In some embodiments, the model performance evaluation module 112 selects a first predicate and pseudo-randomly selects an example from the sample set of examples (E) which satisfies the predicate and labels the selected example for which a first logical value obtained by applying the first predicate to the example is true to obtain a labeled example.

If the selected example is labeled, the selected example can be propagated to its corresponding partition leaf. The label is then an unbiased estimate of the intersection of the set of examples for which the predicate is true, and the partition in which the labeled example landed. To make the labeled example, an unbiased estimate of a leaf partition, the partition the label landed in must be split along the predicate. The previous leaf then becomes a parent, with an associated predicate, and the label becomes an unbiased estimate of the left child. To complete the partition update, the unlabeled examples and the labeled examples from the split partition are propagated to new children.

In some embodiments, the performance metrics of the AI model 110 are selected from any of marginale, precision, recall, and F1 score. The marginale may be represented as P(label(e)=Positive|e∈E).

In some embodiments, the marginale is a probability that the unlabeled example e is positive when sampled randomly. In some embodiments, the marginale is expressed using a law of total probability over the partition

$$marginale = P ( label ( e ) = Positive ) = {\sum }_{i} P ( label ( e ) = Positive \vert e ∈ {U}_{i} ) P ( e ? {U}_{i} )$$

In some embodiments, the precision is represented as

$$P ( model ( e ) \geq k ) = \frac{TP}{TP + FP} ,$$

where TP is the number of examples for which model(e) and label(e) is positive, and FP is the number of examples for which model(e) is positive and label(e) is negative.

In some embodiments, the recall is represented as

$$P ( label ( e ) ) = \frac{TP}{TP + FN} ,$$

where FN is the number of an example where model(e) is negative and label(e) is positive.

In some embodiments, the F1 score is represented as

$$2 \frac{Precision \times Recall}{Precision + Recall}$$

In some embodiments, the precision and the recall are computed as

$$Precision = \frac{TP}{TP + FP} = P ( label ( e ) = Positive \vert model ( e ) \geq k )$$

$$= {\sum }_{i} P ( label ( e ) = Positive \vert model ( e ) \geq k , e ∈ {U}_{i} ) P ( e ∈ {U}_{i} \vert model ( e ) \geq k )$$

$$? {\sum }_{i} P ( label ( e ) = Positive \vert e ∈ {U}_{i} ) P ( e ∈ {U}_{i} \vert model ( e ) \geq k )$$

$$P ( model ( e ) \geq k ) = {\sum }_{i} P ( model ( e ) \geq k \vert e ∈ {U}_{i} ) P ( e ∈ {U}_{i} )$$

$$Recall = P ( model ( e ) >= k \vert label ( e ) = Positive )$$

$$= \frac{P ( label ( e ) = Positive \vert model ( e ) >= k ) P ( model ( e ) \geq k )}{P ( label ( e ) = Positive )}$$

$$= Precision * P ( model ( e ) >= k ) / marginale$$

The model performance evaluation module 112 may create the predicate (e) for the partition Uᵢ by combining the predicates along the path {nodeⱼ} between the root node 302 and the first leaf node 312.

For example, if the path goes to the left, the model performance evaluation module 112 may use the first predicate predⱼ=predicate(nodeⱼ), and if the path goes to the right, the model performance evaluation module 112 may create the second predicate predⱼ=NOT(predicate(nodeⱼ)) by negating the predicate.

In some embodiments, the predicate is expressed as

predᵢ=?_{j∈Path}predⱼ

The predicate is only true for e∈Uᵢ:

?e∈E,predᵢ(e)⇔e∈Uᵢ.

In some embodiments, the sample set of examples (E) is sampled uniformly using predᵢ until elements of Uᵢ are obtained.

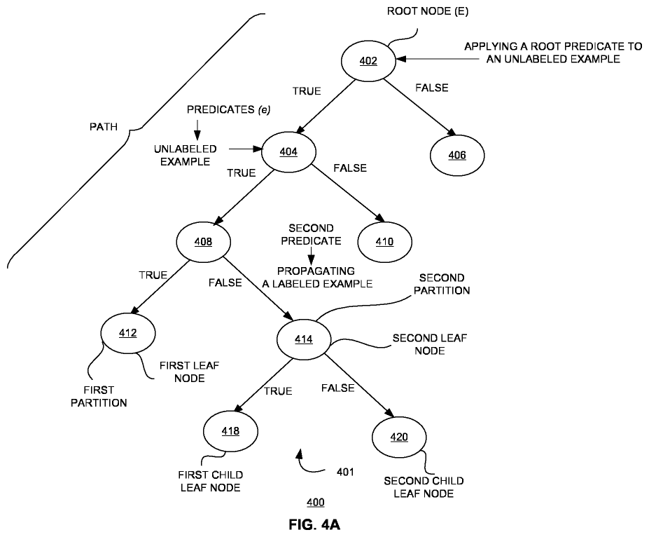

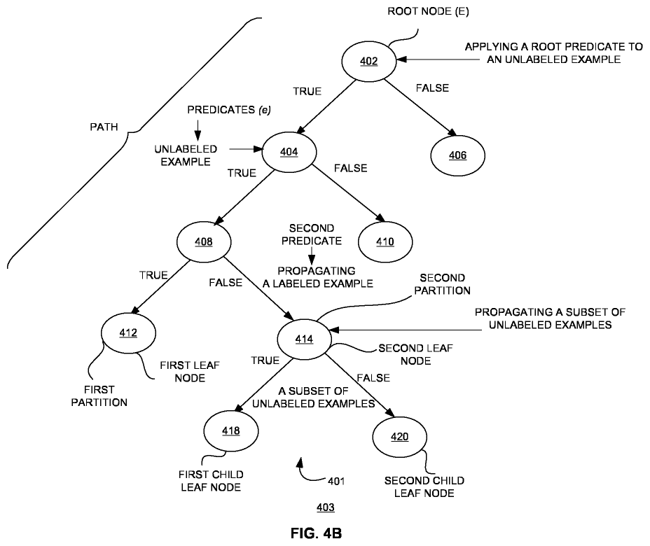

FIG. 4A is an exemplary diagram 400 that illustrates modifying a binary decision tree 401 by splitting a second leaf node 414 into a first child leaf node 418 and a second child leaf node 420 according to some embodiments herein. The exemplary diagram 400 includes a binary decision tree 401 that includes the root node 402, left child nodes 404, 408, and 412, and right child nodes 406, 410, and 414. In some embodiments, each child continues to branch out into left child nodes 404, 408, 412 and right child nodes 406, 410 and 414. For example, the left child node 404 has child nodes such as a left child node 408 and a right child node 410, and the left child node 408 has the child nodes such as a left child node 412 and a right child node 414. In some embodiments, the left child node 412 is a first leaf node and the right child node 414 is a second leaf node. The model performance evaluation module 112 may modify the binary decision tree 401 by splitting the second leaf node 414 into the first child leaf node 418 and the second child leaf node 420 based on a second logical value derived from a second predicate that is applied to the at least one labeled example that has propagated to the second leaf node 414.

FIG. 4B is an exemplary diagram 403 that illustrates performing an incremental update by propagating a subset of unlabeled examples to the second leaf node 414 of FIG. 4A according to some embodiments herein. The model performance evaluation module 112 may perform an incremental update by propagating a subset of the unlabeled examples to the second leaf node 414. In some embodiments, the model performance evaluation module 112 estimates a relative size of the first child leaf node 418 after the incremental update is completed.

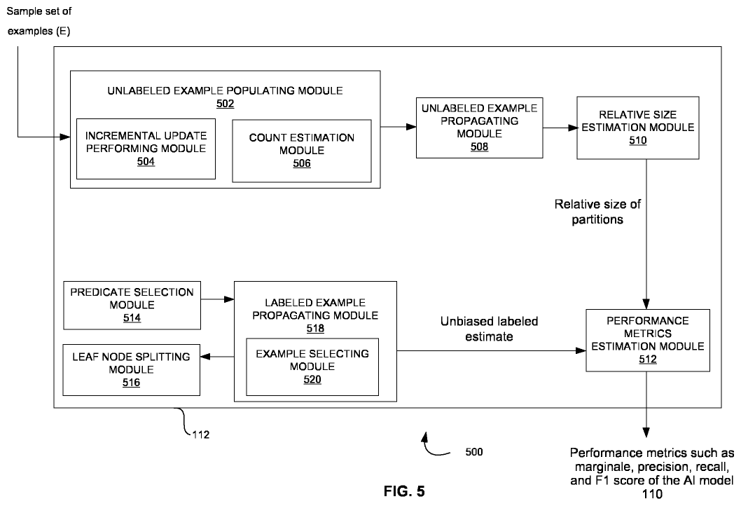

FIG. 5 is a block diagram 500 of the model performance evaluation module 112 of FIG. 1 according to some embodiments herein. The model performance evaluation module 112 includes an unlabeled example populating module 502 that includes an incremental update performing module 504 and a count estimation module 506, an unlabeled example propagating module 508, a relative size estimation module 510, a performance metrics estimation module 512, a predicate selection module 514, a leaf node splitting module 516, and a labeled example propagating module 518 that includes an example selecting module 520.

The unlabeled example populating module 504 populates the binary decision tree 401 by adding at least one unlabeled example from the sample set of examples (E) at a root node of the binary decision tree 401. The at least one unlabeled example may be selected from a batch of examples that are populated at the root node. The unlabeled example propagating module 508 propagates the unlabeled example from the root node to the first leaf node in the binary decision tree 401. The first partition includes the subset of the sample set of examples (E) that have propagated to the first leaf node of the binary decision tree 401.

The unlabeled example may be propagated from the root node to the first leaf node in the binary decision tree 401 by applying a predicate at each parent node along a path from the root node to the first leaf node. The unlabeled example may be propagated from the root node to the first leaf node by (i) applying a root predicate to the unlabeled example at the root node to obtain a logical value, (ii) assigning the unlabeled examples to a left child node of the root node or a right child node of the root node based on the logical value, and (iii) iteratively applying predicates to the unlabeled example at each child node that the unlabeled example is assigned to, until the unlabeled example reaches the first leaf node. The unlabeled examples for which the predicate is true may propagate to the left child node, and the unlabeled examples for which the predicate is false may propagate to the right child node.

The relative size estimation module 510 automatically estimates the relative size of the first partition that corresponds to the first leaf node to derive performance metrics of the AI model 110. The relative size estimation module 510 may estimate the relative size of the first leaf node by dividing a count of unlabeled examples that have propagated to the first leaf node by a total number of unlabeled examples added at the root node. Alternatively, the relative size estimation module 510 may estimate the relative size by determining a ratio of unlabeled examples assigned to each child node to the number of unlabeled examples at its parent node, and estimating a product of the ratio at each child node to be the relative size of the first leaf node, if the unlabeled examples are propagated from the root node to the first leaf node in the binary decision tree 401, for each child node that the unlabeled examples are assigned to along the path between the root node and the first leaf node. This is incrementally more accurate during an asynchronous update since it uses information provided by the unlabeled examples that are populated at the root node of the binary decision tree 401 even if the unlabeled examples have not reached the first leaf node yet.

The performance metrics estimation module 512 estimates the performance metrics of the AI model 110. In some embodiments, the performance metrics are selected from any of marginale, precision, recall, and F1 score.

The count estimation module 506 may estimate a count of unlabeled examples to be added to populate the binary decision tree 401 based on a demand for a number of unlabeled examples needed to propagate down to the first leaf node to achieve a preset target minimum of unlabeled examples at the first leaf node, based on a historical proportion split at each node along the path from the root node to the first leaf node. In some embodiments, the updates of counts are atomic and the updates are performed across multiple threads.

The predicate selection module 514 may select a first predicate. In some embodiments, the first predicate may be selected by the user 102. In some embodiments, the example selecting module 520 pseudo-randomly selects an example from the sample set of examples (E) which satisfies the predicate and labels the selected example for which a first logical value obtained by applying the first predicate to the example is true to obtain a labeled example. The labeled example propagating module 518 may propagate the labeled example to a second partition that corresponds to a second leaf node of the binary decision tree 401 to obtain an unbiased label estimate for an intersection of the second partition and the set of examples satisfying the predicate. Since the example is pseudo-randomly selected, this label provides an unbiased estimate of all the examples that are in the intersection between the set of examples that satisfy the predicate and all the examples that are in the partition that corresponds to the leaf node, where the labeled example has traversed. Once the selected partition has been split and updated using the predicate, the label, as well as all other labels that have been propagated to that partition, is (are) an unbiased estimate(s) of the updated partition. In some embodiments, the performance metrics are derived based at least in part on the unbiased label estimate for the second partition. The performance metrics may be selected from marginale or precision.

The leaf node splitting module 516 may modify the binary decision tree 401 by splitting the second leaf node into a first child leaf node and a second child leaf node based on a second logical value derived from a second predicate that is applied to the at least one labeled example that has propagated to the second leaf node. Splitting the leaf node results in a modification to the structure of the binary decision tree 401, and the binary decision tree 401 grows by the addition of new child nodes that are leaf nodes.

The unlabeled example propagating module 508 may perform an incremental update by propagating a subset of the unlabeled examples, e.g., 50 unlabeled examples to the second leaf node. The relative size estimation module 510 may estimate a relative size of the first child leaf node after the incremental update is completed. Splitting the leaf node results, the relative size of the partition Uᵢ for the second leaf node being updated is unavailable, which means that until the unlabeled examples are propagated to each child node the relative size of the partition Uᵢ for the second leaf node cannot be calculated. In some embodiments, if the second leaf node is split, the relative size of the corresponding partition Uᵢ becomes available.

The incremental update performing module 504 may perform an incremental update by propagating a subset of the unlabeled examples to the second leaf node. In some embodiments, the relative size estimation module 510 estimates the relative size of the first child leaf node after the incremental update is completed.

In some embodiments, the unlabeled example is directed to the left child node if the logical value corresponds to the left child node is true, and the unlabeled example stays in the left child node independent of whether the left child node is a leaf or not until there is a demand from the left child node if there is a demand for an unlabeled example from each child node along the path from the root node to the right child node. Thus, saving computation, until there is a demand from the left child node, as a result of a leaf split.

The unlabeled example may be directed to the right child node if the logical value corresponds to the right child node is false, and the unlabeled example stays in the right child node independent of whether the right child node is a leaf or not until there is a demand from the right child node if there is a demand for an unlabeled example from each child node along the path from the root node to the left child node.

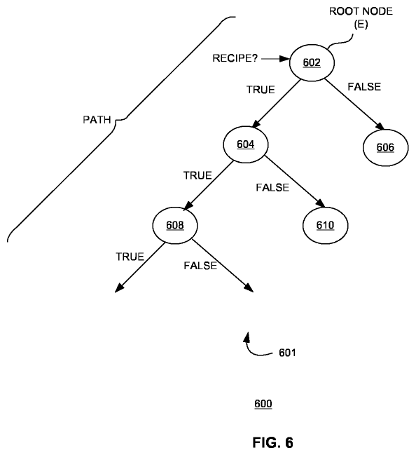

FIG. 6 is an exemplary diagram 600 that illustrates populating a binary decision tree 601 by adding an unlabeled example from a sample set of examples (E) at a root node 602 of the binary decision tree 601 according to some embodiments herein. The sample set of examples (E) is partitioned into the first partition that includes a subset of the sample set of examples (E) that have propagated to a first leaf node 608 of the binary decision tree 601. The unlabeled example is propagated from the root node 602 to the first leaf node 608 in the binary decision tree 601. In some embodiments, the unlabeled example is propagated from the root node 602 to the first leaf node 608 in the binary decision tree 601 by applying a predicate (e) at each parent node, e.g., a node 604 along a path from the root node 602 to the first leaf node 608.

The user 102 may ask a first query (e.g., apply a first predicate) through the user device 104 associated with the user 102, such as, “Show me a document that has the word ‘recipe”, at the root node 602. Based on the query from user 102, the model performance evaluation module 112 may select an unlabeled example that includes the word ‘recipe’, for which the predicate is true. The user 102 may get a document that contains the word recipe, and it may not be a cooking recipe. For example, it may be a numerical recipe, or a cement recipe. In that case, even though the document contains the word recipe, the label is false. Then, the user 102 may put a label on it and the label may be true or false. In some embodiments, the labeled example is propagated to a leaf node that corresponds to a partition. Since the unlabeled example was pseudo-randomly selected, this label provides an unbiased estimate of all the examples that are in the intersection between the set of examples that satisfy the predicate and all the examples that are in the partition that corresponds to the leaf node, where the labeled example has traversed. Once the selected partition has been split and updated using the predicate, the label, as well as all other labels that have been propagated to that partition, is (are) an unbiased estimate(s) of the updated partition.

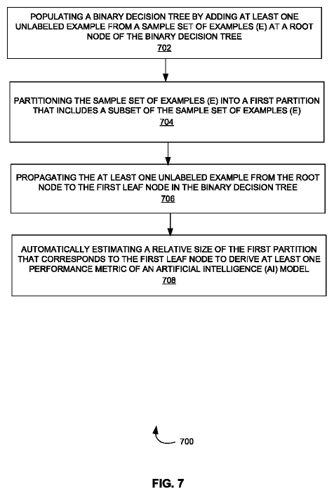

FIG. 7 is a flow diagram that illustrates a method 700 for deriving performance metrics of the artificial intelligence (AI) model 110 that is trained based on a sample set of examples (E), by estimating a relative size of a first partition of the sample set of examples (E) according to some embodiments herein. At step 702, the method 700 includes populating a binary decision tree by adding at least one unlabeled example from the sample set of examples (E) at a root node of the binary decision tree. At step 704, the method 700 includes partitioning the sample set of examples (E) into the first partition that includes a subset of the sample set of examples (E). At step 706, method 700 includes propagating at least one unlabeled example from the root node to the first leaf node in the binary decision tree. The first partition includes the subset of the sample set of examples (E) that have propagated to the first leaf node of the binary decision tree. At step 708, the method 700 includes automatically estimating the relative size of the first partition that corresponds to the first leaf node to derive at least one performance metric of the AI model 110.

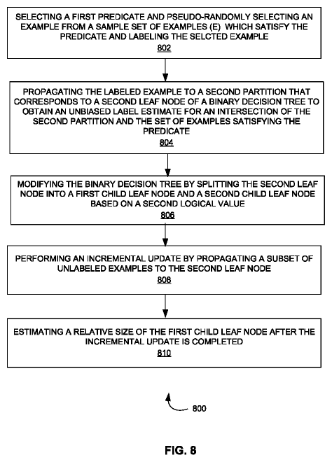

FIG. 8 is a flow diagram that illustrates a method 800 for propagating a labeled example to a second partition that corresponds to a second leaf node of a binary decision tree according to some embodiments herein. At step 802, the method 800 includes selecting a first predicate and pseudo-randomly selecting an example from the sample set of examples (E) which satisfies the predicate and labeling the selected example for which a first logical value obtained by applying the first predicate to the example is true to obtain the labeled example. At step 804, the method 800 includes propagating the labeled example to a second partition that corresponds to a second leaf node of the binary decision tree to obtain an unbiased label estimate for the second partition. In some embodiments, at least one performance metric is derived based at least in part on the unbiased label estimate for an intersection of the second partition and the set of examples satisfying the predicate. In some embodiments, the at least one performance metric is selected from marginale or precision. At step 806, the method 800 includes modifying the binary decision tree by splitting the second leaf node into a first child leaf node and a second child leaf node based on a second logical value derived from a second predicate that is applied to the labeled example that has propagated to the second leaf node. At step 808, the method 800 includes performing an incremental update by propagating a subset of the one or more unlabeled examples to the second leaf node. At step 810, the method 800 includes estimating a relative size of the first child leaf node after the incremental update is completed.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

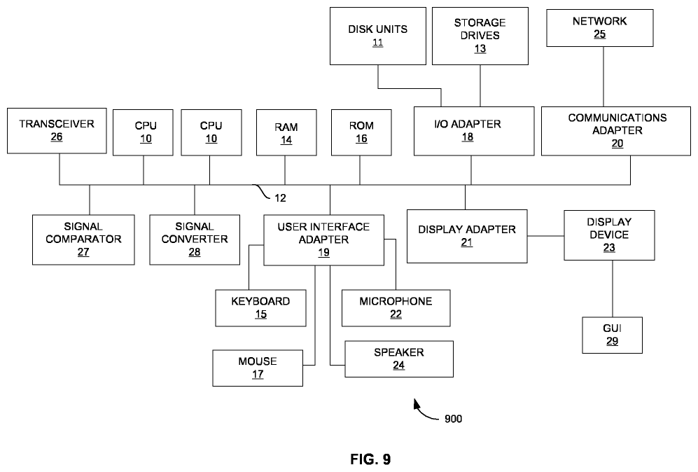

A representative computer hardware environment for practicing the embodiments herein is depicted in FIG. 9, with reference to FIGS. 1 through 8. This schematic drawing illustrates a hardware configuration of a server/computer system/user device in accordance with the embodiments herein. The server 108 includes at least one processing device 10. The special-purpose CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The server 108 can read the inventive instructions on the program storage devices and follow these instructions to execute the methodology of the embodiments herein. The server 108 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23, which provides a graphical user interface (GUI) 29 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method for deriving at least one performance metric of an artificial intelligence (AI) model that is trained based on a sample set of examples (E), by estimating a relative size of a first partition of the sample set of examples (E), the method comprising:
populating a binary decision tree by adding at least one unlabeled example from the sample set of examples (E) at a root node of the binary decision tree;
partitioning the sample set of examples (E) into the first partition that comprises a subset of the sample set of examples (E);
propagating the at least one unlabeled example from the root node to the first leaf node in the binary decision tree, wherein the first partition comprises the subset of the sample set of examples (E) that have propagated to the first leaf node of the binary decision tree; and
automatically estimating the relative size of the first partition that corresponds to the first leaf node to derive at least one performance metric of the AI model.

2. The processor-implemented method of claim 1, wherein the at least one unlabeled example that is added to populate the binary decision tree is selected from a plurality of unlabeled examples that are added at the root node of the binary decision tree, and the at least one unlabeled example is propagated from the root node to the first leaf node in the binary decision tree by applying a predicate at each parent node along a path from the root node to the first leaf node.

3. The processor-implemented method of claim 1, wherein the at least one unlabeled example is propagated from the root node to the first leaf node by applying a root predicate to the unlabeled example at the root node to obtain a logical value, and assigning the at least one unlabeled example to a left child node of the root node or a right child node of the root node based on the logical value, and iteratively applying predicates to the at least one unlabeled example at each child node that the at least one unlabeled example is assigned to, until the at least one unlabeled example reaches the first leaf node.

4. The processor-implemented method of claim 2, further
selecting a first predicate and pseudo-randomly selecting at least one example from the sample set of examples (E) which satisfies the predicate and labeling the at least one selected example for which a first logical value obtained by applying the first predicate to the at least one example is true to obtain at least one labeled example; and
propagating the at least one labeled example to a second partition that corresponds to a second leaf node of the binary decision tree to obtain an unbiased label estimate for an intersection of the second partition and the set of examples satisfying the predicate, wherein the at least one performance metric is derived based at least in part on the unbiased label estimate for the second partition, wherein the at least one performance metric is selected from marginale or precision.

5. The processor-implemented method of claim 4, further comprising
modifying the binary decision tree by splitting the second leaf node into a first child leaf node and a second child leaf node based on a second logical value derived from a second predicate that is applied to the at least one labeled example that has propagated to the second leaf node.

6. The processor-implemented method of claim 1, wherein the relative size of the first leaf node is estimated by dividing a count of unlabeled examples that have propagated to the first leaf node by a total number of unlabeled examples added at the root node.

7. The processor-implemented method of claim 1, wherein if the at least one unlabeled example is propagated from the root node to the first leaf node in the binary decision tree, for each child node that the at least one unlabeled example is assigned to along the path between the root node and the first leaf node, a ratio of unlabeled examples assigned to the each child node to the number of unlabeled examples at its parent node is determined, and a product of the ratio at the each child node is estimated to be the relative size of the first leaf node.

8. The processor-implemented method of claim 5, further comprising
performing an incremental update by propagating a subset of the plurality of unlabeled examples to the second leaf node; and
estimating a relative size of the first child leaf node after the incremental update is completed.

9. The processor-implemented method of claim 1, further comprising
estimating a count of unlabeled examples to be added to populate the binary decision tree based on a demand for a number of unlabeled examples needed to propagate down to the first leaf node to achieve a preset target minimum of unlabeled examples at the first leaf node, based on a historical proportion split at each node along the path from the root node to the first leaf node.

10. The processor-implemented method of claim 1, wherein the at least one performance metric is selected from any of marginale, precision, recall, and F1 score.

11. A system for deriving at least one performance metric of an artificial intelligence (AI) model that is trained based on a sample set of examples (E), by estimating a relative size of a first partition of the sample set of examples (E), comprising:
a processor; and
a non-transitory computer readable storage medium storing one or more sequences of instructions, which when executed by the processor, performs a method comprising:
populating a binary decision tree by adding at least one unlabeled example from the sample set of examples (E) at a root node of the binary decision tree;
partitioning the sample set of examples (E) into the first partition that comprises a subset of the sample set of examples (E);
propagating the at least one unlabeled example from the root node to the first leaf node in the binary decision tree, wherein the first partition comprises the subset of the sample set of examples (E) that have propagated to the first leaf node of the binary decision tree; and
automatically estimating the relative size of the first partition that corresponds to the first leaf node to derive at least one performance metric of the AI model.

12. The system of claim 11, wherein the at least one unlabeled example that is added to populate the binary decision tree is selected from a plurality of unlabeled examples that are added at the root node of the binary decision tree, and the at least one unlabeled example is propagated from the root node to the first leaf node in the binary decision tree by applying a predicate at each parent node along a path from the root node to the first leaf node.

13. The system of claim 11, wherein the at least one unlabeled example is propagated from the root node to the first leaf node by applying a root predicate to the unlabeled example at the root node to obtain a logical value, and assigning the at least one unlabeled example to a left child node of the root node or a right child node of the root node based on the logical value, and iteratively applying predicates to the at least one unlabeled example at each child node that the at least one unlabeled example is assigned to, until the at least one unlabeled example reaches the first leaf node.

14. The system of claim 12, further comprising
selecting a first predicate and pseudo-randomly selecting at least one example from the sample set of examples (E) which satisfies the predicate and labeling the at least one selected example for which a first logical value obtained by applying the first predicate to the at least one example is true to obtain at least one labeled example; and
propagating the at least one labeled example to a second partition that corresponds to a second leaf node of the binary decision tree to obtain an unbiased label estimate for an intersection of the second partition and the set of examples satisfying the predicate, wherein the at least one performance metric is derived based at least in part on the unbiased label estimate for the second partition, wherein the at least one performance metric is selected from marginale or precision

15. The system of claim 14, further comprising
modifying the binary decision tree by splitting the second leaf node into a first child leaf node and a second child leaf node based on a second logical value derived from a second predicate that is applied to the at least one labeled example that has propagated to the second leaf node.

16. The system of claim 11, wherein the relative size of the first leaf node is estimated by dividing a count of unlabeled examples that have propagated to the first leaf node by a total number of unlabeled examples added at the root node.

17. The system of claim 11, wherein if the at least one unlabeled example is propagated from the root node to the first leaf node in the binary decision tree, for each child node that the at least one unlabeled example is assigned to along the path between the root node and the first leaf node, a ratio of unlabeled examples assigned to the each child node to the number of unlabeled examples at its parent node is determined, and a product of the ratio at the each child node is estimated to be the relative size of the first leaf node.

18. The system of claim 15, further comprising
performing an incremental update by propagating a subset of the plurality of unlabeled examples to the second leaf node; and
estimating a relative size of the first child leaf node after the incremental update is completed.

19. The system of claim 11, further comprising
estimating a count of unlabeled examples to be added to populate the binary decision tree based on a demand for a number of unlabeled examples needed to propagate down to the first leaf node to achieve a preset target minimum of unlabeled examples at the first leaf node, based on a historical proportion split at each node along the path from the root node to the first leaf node.

20. The system of claim 11, wherein the at least one performance metric is selected from any of marginale, precision, recall, and F1 score.
